(19) United States
(12) Patent Application Publication
(10) Pub. No.: US 2020/0362592 A1
(43) Pub. Date: Nov. 19, 2020

(54) STRIKING PLATE ASSEMBLY

(71) Applicant: ASSA ABLOY AB, Stockholm (SE)

(72) Inventors: Tomas JONSSON, Rönninge (SE); Mats CEDERBLAD, Hässelby (SE); Johan VON MATERN, Täby (SE)

(21) Appl. No.: 16/961,888

(22) PCT Filed: Dec. 18, 2018
(86) PCT No.: PCT/EP2018/085626

§ 371 Date: Jul. 13, 2020

(30) Foreign Application Priority Data
Jan. 22, 2018 (EP) 18152780.5

(51) Int. Cl. E05B 45/08

(52) U.S. Cl. CPC E05B 45/083; E05B 2047/0069

(57) ABSTRACT

It is provided a striking plate assembly comprising: a striking plate; and a sensor device for detecting a status of a bolt of a lock for a physical barrier, the sensor device comprising a proximity sensor and an antenna; wherein the sensor device is provided such that its proximity sensor is provided displaced, along a longitudinal direction of the striking plate, from a through-hole through which the bolt is intended to pass. The sensor device is provided such that its antenna is directed towards a gap between the striking plate assembly and the physical barrier, when the striking plate assembly is installed.

### TECHNICAL FIELD

The invention relates to a striking plate assembly comprising a striking plate and a sensor device.

### BACKGROUND

Locks and keys are evolving from the traditional pure mechanical locks. These days, electronic locks are becoming increasingly common. For electronic locks, electronic keys are used for authentication of a user. The electronic keys and electronic locks can communicate either over a wireless interface or a conductive interface. Such electronic locks and keys provide a number of benefits, including improved flexibility in management of access rights, audit trails, key management, etc.

In electronic locks, information of a status of a barrier (such as a door or a window) is often beneficial, whereby a sensor can be provided in the lock to detect the status of a bolt.

However, providing the sensor in the lock can be complicated and retrofitting of such sensors is quite difficult.

It is known to have a magnet sensor which comprises a magnet and a corresponding wireless sensor comprising a reed switch and wireless communication module. The magnet it provided on the barrier and the wireless sensor is provided on the frame around the barrier. The magnet sensor can in this way detect when the barrier is open or closed.

U.S. Pat. No. 6,078,256 A discloses a dead-bolt lock monitoring unit and system. GB 2 505 003 A discloses a fenestration alarm contact sensor for determining a locked and unlocked configuration.

### SUMMARY

It is an object to provide a way to detect bolt position with a sensor device which simplifies retrofitting and enables a strong structure.

According to a first aspect, it is provided a striking plate assembly comprising: a striking plate; and a sensor device for detecting a status of a bolt of a lock for a physical barrier, the sensor device comprising a proximity sensor and an antenna; wherein the sensor device is provided such that its proximity sensor is provided vertically displaced, along a longitudinal direction of the striking plate, from a through-hole through which the bolt is intended to pass. The sensor device is provided such that its antenna is directed towards a gap between the striking plate assembly and the physical barrier, when the striking plate assembly is installed.

The proximity sensor may face the space where the locking bolt is intended to pass when extended.

The striking plate may comprise a first through-hole between the sensor device and the gap between the striking plate assembly and the physical barrier, when the striking plate assembly is installed.

The sensor device may be provided in the first through-hole such that the sensor device is essentially in the same plane as sections of the striking plate around the first through-hole, wherein the plane is the surface towards a gap between the striking plate assembly and the physical barrier, when the striking plate assembly is installed.

The striking plate may comprise a second through-hole between the sensor device and where the bolt is intended to pass. Alternatively, a single through-hole is used for both the bolt and the sensor device.

The proximity sensor may be an inductive sensor.

The sensor device may be attached to the striking plate.

The striking plate assembly may be applied for when the bolt is a locking bolt and/or a latch bolt.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram showing an environment in which embodiments presented herein can be applied;

FIG. 2 is a schematic diagram illustrating one embodiment of a striking plate assembly;

FIG. 3 is a schematic side view diagram illustrating an embodiment of sensor placement by the striking plate of FIG. 2;

FIG. 4 is a schematic perspective view diagram illustrating an embodiment of sensor placement by the striking plate of FIG. 2; and

FIG. 5 is a schematic perspective view diagram illustrating the embodiment of FIG. 4 in more detail.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Embodiments presented herein are based on the realisation that the placement of a proximity sensor in a striking plate assembly has great implications on structural strength of the striking plate assembly. In particular, by placing the sensor device vertically displaced longitudinally (typically vertically) from a through-hole through which a bolt is intended to pass, no major structural weakening is required and the striking plate assembly can be easily retrofitted. Additionally, this placement of the sensor device allows efficient sensing of the bolt by the proximity sensor.

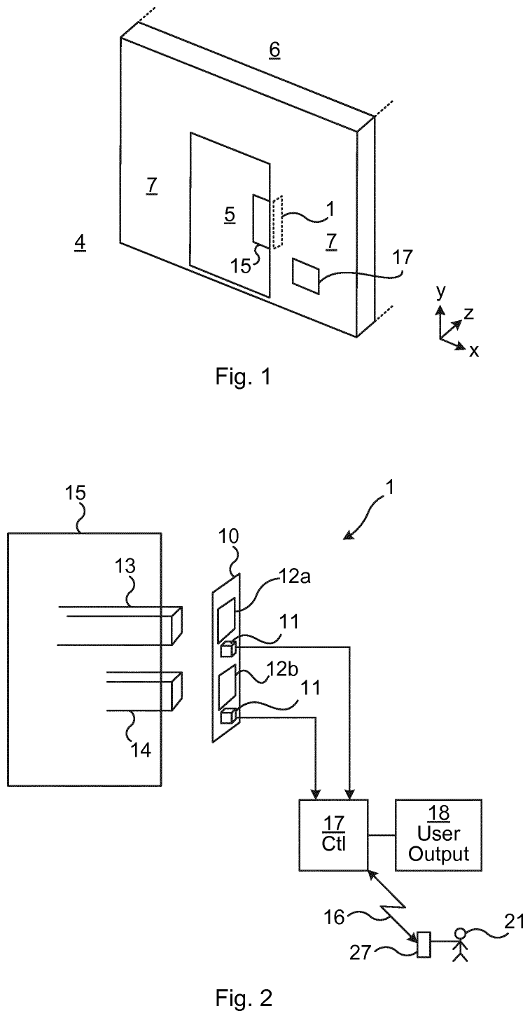

FIG. 1 is a schematic diagram showing an environment in which embodiments presented herein can be applied. Access to a physical space 6 is restricted by a physical barrier 5 which is selectively controlled to be in a locked state or an unlocked state. The physical barrier 5 can be a door, window, gate, hatch, cabinet door, drawer, etc. The physical barrier 5 is provided in a surrounding physical structure 7 (being a wall, fence, ceiling, floor, etc.) and is provided between the restricted physical space 6 and an accessible physical space 4. It is to be noted that the accessible physical space 4 can be a restricted physical space in itself, but in relation to this physical barrier 5, the accessible physical space 4 is accessible.

A striking plate assembly 1 is provided in the surrounding physical structure 7.

In one embodiment, the lock 15 is an electronic lock. In order to unlock the barrier 5, a controller 17 is then provided. The controller 17 is connected to a lock 15, which is controllable by the controller 17 to be set in an unlocked state or locked state, as explained in more detail below. It is to be noted that the lock 15 can be provided in the physical barrier 5 as shown or in the surrounding structure 7 (not shown). Optionally, the controller 17 forms part of the lock 15.

Alternatively, the lock is a mechanical lock, for which the locked/unlocked state is desired to be monitored.

FIG. 2 is a schematic diagram illustrating one embodiment of a striking plate assembly 1. The striking plate assembly 1 comprises a striking plate 10 and at least one sensor device 11. In this embodiment, there are two sensor devices 11. The striking plate is made of metal and secures the position of a locking bolt 13 when extended from the lock 15 into the surrounding structure 7, thus making it difficult for an attacker to break open the barrier.

The striking plate assembly 1 is for use with a lock 15 which comprises a locking bolt 13. The striking plate 10 comprises a first bolt through-hole 12a through which the locking bolt 13 can pass. When the locking bolt 13 passes through the bolt through-hole 12a, the lock 15 is in a locked state.

The sensor device 11 of the striking plate assembly 1 is used for detecting a status of the locking bolt 13. The status is either that the bolt has been extended through the striking plate or that the bolt is not extended through the striking plate. When applied for the locking bolt 13, when this is extended through the striking plate, this indicates that the lock is in a locked state. Conversely, when the locking bolt 13 is not extended through the striking plate, the lock is in unlocked state. The sensor device 11 is provided attached to the striking plate 10, such that its proximity sensor is vertically displaced, along a longitudinal direction of the striking plate, from the through-hole 12a, 12b through which where the locking bolt 13 is intended to pass. The longitudinal direction of the striking plate is along the gap between the barrier and surrounding structure. When the barrier is provided in a side-hung manner, the longitudinal direction is vertical. In other words, in one embodiment, the longitudinal direction is vertically.

This structure makes the sensor device 11 hidden when the barrier is closed, which reduces a risk of inadvertent damage or external sabotage to the sensor device 11, while maintaining an aesthetic appearance. The sensor device can be provided below or above from where the locking bolt 13 is intended to pass.

By providing the sensor device vertically displaced along the longitudinal direction (typically vertically) from the bolt, integration of the striking plate assembly is simplified while keeping the structure strong where the striking plate assembly is installed. If the sensor device were to be provided horizontally displaced from where the bolt is intended to go, that would weaken the structure of the installation and thus security of the whole barrier locking. Moreover, if the sensor device were to be placed further in from where the bolt extends, this would dramatically reduce signal strength of wireless signals to/from the credential antenna. The credential antenna is used to communicate with an external credential over a user credential interface 16, described in more detail below.

By providing the sensor device as part of the striking plate assembly 1, the whole striking plate assembly can easily replace a previous striking plate, greatly simplifying retrofitting to provide capability to detect status of the barrier (locked/unlocked).

For windows and for some doors, such as double doors, there is an espagnolette. The espagnolette has several hooks which engage with corresponding small striking plates or a long striking plate with corresponding through-holes. For espagnolettes, the striking plates might be too small to also fit a sensor device. Hence, in one embodiment, a dummy hook forms part of the espagnolette where a corresponding sensor device is provided in the striking plate assembly by the through-hole corresponding to the dummy hook. In this way, the sensor device can detect when the barrier is closed and bolted. The sensing can be achieved by the proximity sensor being an inductive sensor, which is able to detect the presence or absence of a hook comprising metal.

The proximity sensor can be based on any one or more of electrical capacity, electrical inductivity, infrared light, magnetism (e.g. a hall sensor), photocell, sonar, mechanical switch etc. When the proximity sensor is an inductive sensor, this simplifies retrofitting, since a regular metal locking bolt presence can be detected with an inductive sensor. The sensor device 11 can be a self-contained device comprising the proximity sensor, battery, antenna(s), and control circuitry. Such a sensor device 11 is easy to integrate in the striking plate and can be replaced or upgraded when needed.

The controller 17 is connected to the sensor device 11. The interface between the controller 17 and the sensor device 11 can be implemented using a wireless interface, e.g. using Bluetooth, Bluetooth Low Energy (BLE), any of the IEEE 802.15 standards, Radio Frequency Identification (RFID), any of the IEEE 802.11 standards, wireless USB (Universal Serial Bus), etc.

The interface between the controller 17 and the lock 15, when provided separately, can be implemented over any suitable wired or wireless interface, such as BLE or USB.

Moreover, the controller 17 comprises a user credential interface 16 for communicating with a user credential 27. The user credential interface 16 can be implemented using any suitable wireless interface, e.g. using Bluetooth, BLE, any of the IEEE 802.15 standards, RFID, Near Field Communication (NFC), any of the IEEE 802.11 standards, wireless USB, etc. Alternatively or additionally, the user credential interface 16 can be implemented using wire-based communication, e.g. using USB, Ethernet, serial connection (e.g. RS-485), etc.

Optionally, the controller 17 is provided with a way to communicate with a remote control device (not shown), such as a smart phone, computer etc. for remote lock management. Using the remote communication, the controller 17 is remotely controllable, e.g. to allow access for a particular user credential or to remotely unlock the lock (e.g. for a tradesman, cleaner, child who have lost a key, etc.). Also, the remote communication enables event monitoring, e.g. of unlocking status, locking status, opening, closing, etc., which can be detected by the sensor device.

The controller 17 can be hardware based, e.g. using an Application Specific Integrated Circuit (ASIC), a Field Programmable Gate Array (FPGA), and/or discrete components. Alternatively or additionally, the controller 17 is software based, comprising a processor using any combination of one or more of a suitable central processing unit (CPU), microcontroller, digital signal processor (DSP), etc., capable of executing software instructions stored in a persistent memory accessible to the controller 17.

The user credential 27 can be implemented using any suitable device portable by a user and which can be used for authentication over the credential interface 16. The user credential 27 is typically carried or worn by the user 8 and may be implemented as a mobile phone, a smartphone, a key fob, wearable device, smart phone case, access card, electronic physical key, etc.

Using the user credential interface 16, the authenticity of the user credential 27 can be checked by the controller 17 in an access control procedure, e.g. using a challenge and response scheme. The authorisation to open the lock 15 is then checked, either by the controller 17 itself, or by communicating with an external (local or remote) authorisation device (not shown) to reach an access decision whether to grant or deny access.

The controller 17 also receives sensor data from the sensor device 11 indicating the presence or absence of a locking bolt 13. Presence of the locking bolt 13 indicates an extended locking bolt 13, corresponding to a locked state, and absence of the locking bolt 13 indicates a retracted locking bolt 13, corresponding to an unlocked state.

The controller 17 is configured to selectively control the lock 15 based on sensor data received from the sensor device 11 and user credential data received over the credential interface 16.

Using the access decision and the sensor data, the controller 17 determines whether to retract or extend the locking bolt 13 by sending an appropriate control signal to the lock 15.

For instance, when the locking bolt 13 is extended and the access decision is to grant access, the controller 17 sends a control signal to the lock 15 to retract the locking bolt 13 to thereby alter the state of the lock 15 from locked to unlocked. When the locking bolt 13 is retracted and the access decision is to grant access, the controller 17 does not send any control signal to the lock 15 to retract the locking bolt 13, since the locking bolt 13 is already retracted, i.e. the lock is already in the unlocked state.

When the locking bolt is extended and the access decision is to deny access, the controller 17 does not send any control signal to the lock 15 to retract the locking bolt 13 since the state of the lock 15 is already in the correct state, i.e. the locked state.

By providing the sensor device in the striking plate assembly 1 rather than in the lock, a cost effective status control of a lock and door is achieved. For instance, this greatly improves the ease and cost with which an existing lock installation can be upgraded to an electronic lock by a simple retrofit. The lock 15 itself can remain as before (or upgraded separately) and only the striking plate assembly is replaced after which the state of locked or unlocked can be determined using the sensor device of the striking plate assembly 11.

Moreover, if it is desired to only add the ability to detect a status of the locking bolt (locked/unlocked) for an existing mechanical, the striking plate assembly can be installed and configured to provide this functionality.

Optionally, the striking plate assembly 1 further comprises a second sensor device 11 for detecting a status of a separate latch bolt 14 of the lock 15 to gain better information about the status of the door. When the latch bolt 14 is present, this indicates that the barrier 5 is closed. Conversely, when the latch bolt 14 is absent, this indicates that the barrier is open. Hence, the presence or absence of the latch bolt 14 in a second bolt through-hole 12b of the striking plate 10, as detected by the second sensor device 11 and transmitted as sensor data to the controller 17, can be interpreted as whether the barrier 5 is open (when the latch bolt 14 is absent) or closed (when the latch bolt 14 is present).

A user output device 18 can also be provided connected to the controller 17. The user output device 18 can be any one or more of a LED (light emitting diode), lamp, beeper, sound device, display, etc. The controller 17 is then configured to provide user feedback via the user output device 18. For instance, the user feedback can be used to indicate any of the following situations: access granted, access denied, access granted but no change (e.g. if the barrier is already open), etc. When the controller 17 is remotely controllable, the user output can optionally be provided in parallel to a device performing the remote control. For instance, if a user remotely unlocks the door for a tradesman, the successful unlocking can result in a green LED indicating that the door is unlocked to the tradesman, as well as an indicator on the user interface of the remote control device.

Optionally, the controller is configured to use the user output device 18 to indicate status of other locks when the user locks the barrier on the outside. For instance, an indication can be shown that all other locks are in a locked state or that at least one lock is in an unlocked state.

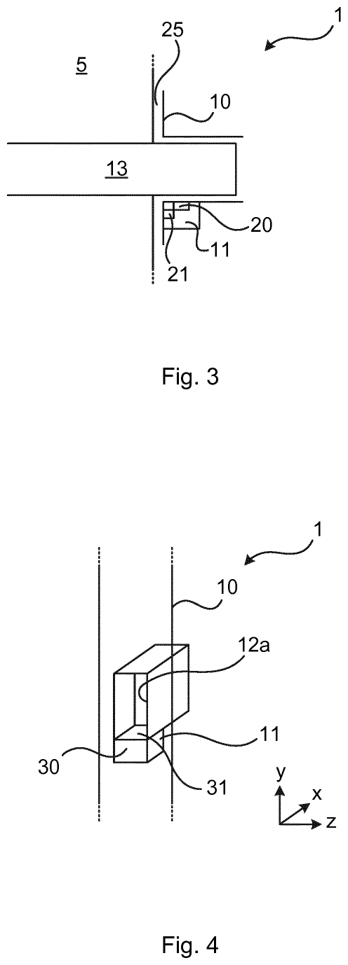

FIG. 3 is a schematic side view diagram illustrating an embodiment of sensor placement by the striking plate 10 of FIG. 2. As shown in FIG. 3, the sensor device 11 is provided below and adjacent along the open space where the locking bolt 13 can extend. In particular, the proximity sensor 20 is directed in towards where the locking bolt can extend. The proximity sensor 20 can comprise a proximity antenna. Alternatively or additionally, the same principle can be applied for a latch bolt 14.

The sensor device 11 is provided such that its credential antenna 21 is directed towards a gap 25 between the striking plate assembly and the physical barrier, when the striking plate assembly 1 is installed, which is on the left side of the sensor device 11 in FIG. 3. When the credential antenna 21 is made up of multiple antennas, such as an inductive credential antenna for RFID/NFC and an RF (Radio Frequency) credential antenna for BLE, all credential antennas are directed in the same direction, towards the gap 25 between the striking plate assembly and the physical barrier, when the striking plate assembly 1 is installed. In this way, communication to/from the credential antenna 21 can pass through the gap 25 between the physical barrier 5 and the striking plate 10, even when the barrier is closed. This allows communication to occur efficiently, even in situations when one or both of the physical barrier 5 and the surrounding structure is made partly or completely of metal.

FIG. 4 is a schematic perspective view diagram illustrating an embodiment of sensor placement by the striking plate 10 of FIG. 2. FIG. 4 corresponds to the embodiment illustrated in FIG. 3.

In FIG. 4, a first through-hole 30 of the striking plate 10 can be seen. The sensor device 11 is provided in the first through-hole 30. In this way, the first through-hole 30 is provided between the sensor device 11 and the gap between the striking plate assembly and the physical barrier, when the striking plate assembly is installed.

The sensor device can be provided in the first through-hole 30 such that the sensor device 11 is essentially (+−3 mm or even +−1 mm) in the same plane as sections of the striking plate around the first through-hole 30. The plane is then the surface towards the gap 25 between the striking plate assembly and the physical barrier, when the striking plate assembly (1) is installed. By providing the sensor device 11 in essentially the same plane as the surrounding striking plate surface, the sensor device 11 is protected from external damage, while any negative effects of the striking plate is reduced for communication to or from the antenna 21.

Furthermore, a second through-hole 31 is shown. The second through-hole 31 is provided between the sensor device 11 and where the locking bolt is intended to pass, i.e. in the space inside the first bolt through-hole 12a. Alternatively or additionally, the same principle can be applied for a latch bolt.

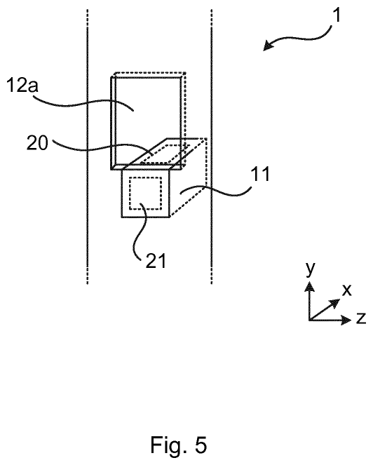

FIG. 5 is a schematic perspective view diagram illustrating the embodiment of FIG. 4 in more detail. In FIG. 5, it is seen how the proximity sensor 20 of the sensor device 11 faces the space where the locking bolt 13 is intended to pass when extended, i.e. in the space inside the first bolt through-hole 12a. In other words, the proximity sensor can detect when the locking bolt passes through the first bolt through-hole (i.e. when the locking bolt is locked) and when it does not (i.e. when the locking bolt is unlocked). Furthermore, the antenna 21 of the sensor device is directed towards the gap 25 between the striking plate assembly and the physical barrier, when the striking plate assembly 1 is installed.

It is to be note that although the locking bolt is here shown to move in a pure linear movement, the locking bolt can equally well be movable in a rotational movement or a movement being a combination of rotational and linear movement. Alternatively or additionally, the same principle can be applied for a latch bolt.

i. A striking plate assembly comprising:
a striking plate; and
a sensor device for detecting a status of a bolt of a lock for a physical barrier, the sensor device comprising a proximity sensor and an antenna;
wherein the sensor device is provided such that its proximity sensor is provided vertically displaced, along a longitudinal direction of the striking plate, from where the bolt is intended to pass.

ii. The striking plate assembly according to embodiment i, wherein the sensor device is provided such that its antenna is directed towards a gap between the striking plate assembly and the physical barrier, when the striking plate assembly is installed.

iii. The striking plate assembly according to embodiment ii, wherein the striking plate comprises a first through-hole between the sensor device and the gap between the striking plate assembly and the physical barrier, when the striking plate assembly is installed.

iv. The striking plate assembly according to embodiment iii, wherein the sensor device is provided in the first through-hole such that the sensor device is essentially in the same plane as sections of the striking plate around the first through-hole, wherein the plane is the surface towards the gap between the striking plate assembly and the physical barrier, when the striking plate assembly is installed.

v. The striking plate assembly according to any one of the preceding embodiments, wherein the striking plate comprises a second through-hole between the sensor device and where the bolt is intended to pass.

vi. The striking plate assembly according to any one of the preceding embodiments, wherein the proximity sensor is an inductive sensor.

vii. The striking plate assembly according to any one of the preceding embodiments, wherein the sensor device is attached to the striking plate.

viii. The striking plate assembly according to any one of the preceding embodiments, wherein the bolt is a locking bolt.

ix. The striking plate assembly according to any one of the preceding embodiments, wherein the bolt is a latch bolt.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A striking plate assembly comprising:
a striking plate; and
a sensor device or detecting a status of a bolt of a lock for a physical barrier, the sensor device comprising a proximity sensor and an antenna;
wherein the sensor device is provided such that its proximity sensor is provided vertically displaced, along a longitudinal direction of the striking plate, from a through-hole through which the bolt is intended to pass; and the sensor device is provided such that its antenna is directed towards gap between the striking plate assembly and the physical barrier, when the striking plate assembly is installed.

2. The striking plate assembly according to claim 1, wherein the proximity sensor faces the space where the locking bolt is intended to pass when extended.

3. The striking plate assembly according to claim 1, wherein the striking plate comprises a first through-hole between the sensor device and the gap between the striking plate assembly and the physical barrier; when the striking plate assembly is installed.

4. The striking plate assembly according to claim 3, wherein the sensor device is provided in the first through-hole such that the sensor device is essentially in the same plane as sections of the striking plate around the first through-hole, wherein the plane is the surface towards the gap between the striking plate assembly and the physical barrier, when the striking plate assembly is installed.

5. The striking plate assembly according to claim 1, wherein the striking plate comprises a second through-hole between the sensor device and where the bolt is intended to pass.

6. The striking plate assembly according to claim 1, wherein the proximity sensor is an inductive sensor.

7. The striking plate assembly according to claim 1, wherein the sensor device is attached to the striking plate.

8. (canceled)

9. (canceled)
